(19) United States
(12) Patent Application Publication
(10) Pub. No.: US 2006/0011668 A1
(43) Pub. Date: Jan. 19, 2006

(54) Dispenser seal device and method

(75) Inventor: Jennifer Massey, North Hollywood, CA (US)

Correspondence Address: Haight, Brown & Bonesteel, LLP;Suite 800, 6080 Center Drive, Los Angeles, CA, 90045, US

(73) Assignee: The Hardway, LLC

(21) Appl. No.: 10/893,587

(22) Filed: Jul. 17, 2004

(51) Int. Cl. B65D 47/00; B67D 3/00

(52) U.S. Cl. 222/562

(57) ABSTRACT

The present invention is a dispenser seal device and method. Numerous, differing types of exposure with dispensers and dispenser spigots are anticipated and protected against by the present invention. A dispenser is exposed to numerous kinds of bacteria. This exposure can come from various sources including pets or pests attempting to access the spigot, contact from human hands and fingers, dust, airborne bacteria and other types of exposure. The present invention provides a seal protecting a dispenser against such exposure, which would otherwise result in bacterial transmission. It is anticipated that the present invention may be of varied configuration, size, and material construction.

### BACKGROUND OF THE INVENTION

The mention of certain references in this section is not an admission that such references are, or qualify to be, prior art with respect to the present invention.

1. Field of Invention

The present invention relates to dispenser technology devices and methods. More specifically, the present invention relates to a dispenser seal that protects a dispenser from exposure to bacteria and other undesirable elements.

2. Description of the Prior Art

Modernly, bottled drinking water is becoming more prevalent, particularly in homes and offices. Reports show that consumers can spend upwards of $300.00 per household over the course of a year in bottled water. This demand is largely driven by the desire to obtain drinking water that is safe and bacteria-free.

Over the past 20 years, demand for bottled water has generally been on the rise. Estimates show that in 2002, bottled water consumption tripled since 1991. Revenues for bottled water sales totaled approximately $7.6 billion in 2002, according to the Beverage Marketing Corporation. Driven also by current trends towards healthier life styles, it appears the bottled water industry will continue to grow in the future.

Dispensers, such as water dispensers, are commonly available in homes and offices. Such dispensers usually have a spigot where the contents of the dispenser can be accessed. While the spigot shuts off the flow of the contents after the user is finished, generally some of the contents remains in and around the spigot. This is particularly true of water dispensers.

Because of this problem, animals, such as cats, dogs and other pets, may attempt to access the spigot to obtain water. Furthermore, insects, rodents and other pests may attempt to access the spigot for the same purpose. As such, bacteria from these animals may be easily transferred to the spigot, and thereafter to subsequent users of the dispenser.

In addition to the above types of exposure to the bacteria, user hands and fingers, dust, and users seeking to refill water bottles may deposit bacteria, or otherwise make the contents of the dispenser undesirable. Such bacterial proliferation can extend beyond the spigot and travel into the dispenser itself, thereby creating further problems.

In an attempt to address the problems associated with bacterial proliferation in dispensers, a number of references exist that generally address bacterial contamination of dispensers. For example, in the reference to Matsui, et al., U.S. Pat. No. 5,366,619, a germ free drinking water dispenser is disclosed. This reference requires the incorporation of an ozone injecting device that acts to sterilize the reservoir area of a water dispenser thereby maintaining the sterilized quality of the drinking water found in the original water dispenser container. The Matsui reference involves complicated, and expensive, improvements to existing water dispensers. Also, this reference does not address the specific issue of bacteria transmitted to consumers from a dispenser spigot.

In another example, the reference to Mellon, U.S. Pat. App. No. 2002/0100767 A1, discloses a container for holding liquids that discourages the user from putting his or her mouth on the container to access the contents. While this reference may prevent or deter the transmission of bacteria by avoiding direct mouth contact in liquid containers, once again, it does not address the problems associated with transmitting bacteria through a water dispenser spigot. Furthermore, this reference involves a relatively complicated incorporation of drink guards which will negatively affect the cost of manufacture.

Accordingly, it is desirable to have a dispenser seal that addresses the problems associated with bacterial contamination emanating from dispenser spigots. Further, it is desirable to have a device that addresses the problems found in the prior art in an efficient and effective manner. However, and in view of the foregoing, nothing in the prior art addresses these problems.

### SUMMARY OF THE INVENTION

The present invention is a dispenser seal device and method. The present invention combines a number of desirable features all housed in an efficient, portable, reusable, disposable and convenient device and method.

In one preferred embodiment, the present invention comprises a fastener which is designated to fit onto a water dispenser spigot, or like device. The present invention allows the dispenser spigot to be protected from outside access or contact, be it from animals, pets, pests, dust, and airborne bacterial and the like. This is accomplished by sealing the dispenser spigot opening from external sources of bacteria. It is anticipated the present invention may be of varied configuration, size, shape, and material construction.

An alternative embodiment of the present invention incorporates disposability of the present invention, so that after repeated uses, the present invention may be discarded and a new unit replaced in its stead, thereby assuring further bacterial protection.

In another alternative embodiment of the present invention, the present invention may be constructed of plastic, rubber, or other like materials. Such materials may also be of varying colors or translucent. In another preferred alternative embodiment of the present invention, the present invention may be attached to a connector assembly associated with a water dispenser, whereby the present invention is accessible even when not connected to the water dispenser spigot.

It is therefore an object of the present invention to provide a new and improved multi-purpose dispenser seal that has all the advantages of the prior art, yet none of the disadvantages. It is a further object of the present invention to provide a new and improved dispenser seal that may be easily and efficiently manufactured and marketed. It is yet a further object of the present invention to provide a new and improved dispenser seal that is of durable and reliable construction.

Another further object of the present invention is to provide a new and improved dispenser seal that is of low cost to manufacture with regard to both materials and labor, and which, accordingly, is then susceptible of low prices of sale to the consuming public, thereby making the present invention economically available to the buying public.

Yet another object of the present invention is to provide a new and improved dispenser seal that is portable and can be used in a myriad of locations and situations.

The present invention may be better understood by referring to the following Detailed Description, which should be read in conjunction with the accompanying Drawings. The Detailed Description of a particular preferred embodiment, described below, is intended to be a particular example, and not a limitation.

### BRIEF DESCRIPTION OF THE DRAWINGS

The accompanying Drawings, which are incorporated in and constitute a part of the specification, illustrate preferred embodiments of the present invention, and together with the preceding general description and the following Detailed Description, explain the principles of the present invention.

In the Drawings:

FIG. 1 is an illustration of a preferred embodiment of the present invention. It is anticipated the present invention can take a number of configurations, sizes and shapes, yet still provide the same benefit.

FIG. 2 is an illustration of a preferred embodiment of the present invention operably mounted on a dispenser spigot.

FIG. 3A is an illustration of a preferred embodiment of the present invention incorporating a connector assembly.

FIG. 3B is an illustration of a preferred embodiment of the present invention incorporating an alternative embodiment of the connector assembly.

FIG. 4 is an illustration of an alternative preferred embodiment of the present invention.

FIG. 5 is an illustration of an alternative preferred embodiment of the present invention mounted to a dispenser spigot.

FIG. 6A is an illustration of the alternative preferred embodiment of the present invention incorporating a connector assembly.

FIG. 6B is an illustration of the alternative preferred embodiment of the present invention incorporating an alternative embodiment of the connector assembly.

### DETAILED DESCRIPTION OF THE INVENTION

Embodiments consistent with the present invention address the need for an efficient dispenser seal. While the prior art attempts to address this need, only the present invention provides a device and method that adequately addresses this need. The device and method described herein may be implemented in a variety of manners. Accordingly, the description of a particular embodiment herein is intended only for the purposes of example, and not as a limitation.

FIG. 1 illustrates a preferred embodiment of the present invention. The types of exposure anticipated and protected against include, but are not limited to, user hands and fingers, dust, animals such as cats, dogs and other pets seeking water, insects and rodents, bottle openings coming in contact during refilling, and introduction of airborne bacteria and the like.

Dispensers, such as water dispensers, are commonly available in homes and offices. Such dispensers usually have a spigot opening where the contents of the dispenser can be accessed. While the spigot shuts off the flow of the contents after the user is finished, generally some of the contents remain. This is particularly true of water dispensers.

Because of this problem, animals, such as cats, dogs and other pets, may attempt to access the valve spigot to obtain water. Furthermore, insects, rodents and other pests may also attempt to access the spigot for the same purpose. As such, bacteria from these animals may be easily transferred to the spigot, and thereafter to subsequent users of the dispenser.

In addition to the above types of exposure to the bacteria, user hands and fingers, dust, and users seeking to refill water bottles may also deposit bacteria, or otherwise make the contents of the dispenser undesirable. Such bacterial proliferation can extend beyond the spigot and travel into the dispenser itself, thereby creating further problems. Also, dispensers can leak causing flooding damage, and create risks associated with a slippery floor, such as a slip and falls. Further, the risk of infants drowning in collected pools of liquid may exist. The present invention addresses these problems in an efficient framework.

While the embodiments in the Drawings illustrate a seal of generally cylindrical shape, the present invention contemplates numerous configurations comprising different shapes, sizes and textures. Furthermore, the present invention may be constructed of varying materials, including but not limited to, hard plastics, malleable plastics, metals, rubber-like compounds, and other materials. Such materials may also be of varying colors or translucent. The present invention may be constructed as one piece, or may be an assembly of multiple pieces.

In one embodiment of the present invention, a fastener (10) is formed such that the fastener (10) may be mounted to a dispenser spigot (200). The fastener (10) mounts to the spigot (200) in manners known in the art, such as by frictional contact, pressure fit, helical tapering or other manners, such that the spigot (200) and fastener (10) are disposed near to each other and remain in place. A base (20) formed on the fastener (10) protects the spigot (200) from outside sources of contact and bacteria.

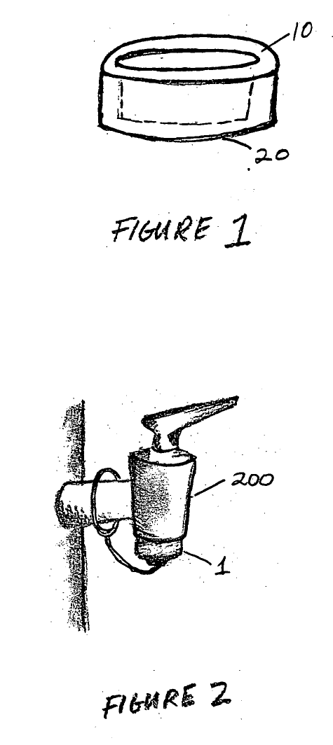

FIG. 2 illustrates the present invention mounted to a typical dispenser spigot (200). Because the present invention seals the dispenser spigot (200) from any outside contact, the transmission of bacteria to the spigot (200) is greatly minimized or eliminated altogether. As such, not only is the spigot (200) protected from bacteria, but ultimately, the dispenser itself is protected from bacteria that would travel and proliferate from the spigot (200) into the dispenser.

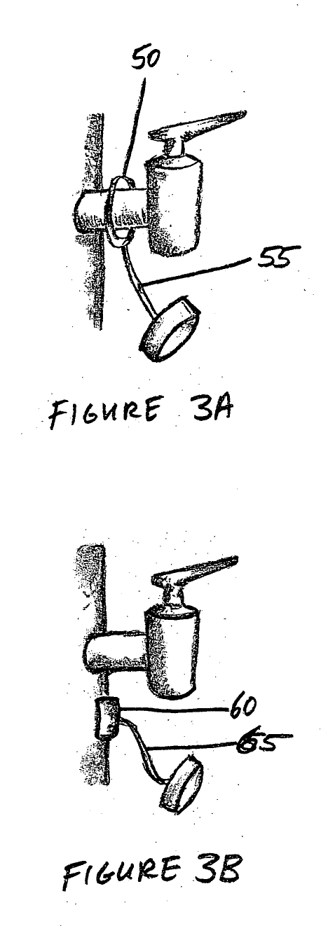

FIG. 3A illustrates the present invention in conjunction with a connector assembly (50, 55). The connector assembly (50, 55) comprises a ring (50) that may be fit over a dispenser spigot (200), or otherwise mounted thereto. A leash (55) is connected to the ring (50) at one end. At the other end of the leash (55), the present invention is connected. As such, the present invention may be removed from the spigot (200) while, at the same time, allowing the present invention to be positioned near and accessible to the dispenser, should later use be required. For example, a user simply removes the present invention from the spigot (200) and lets it dangle on the leash (55), where it may later be easily replaced on the spigot (200).

FIG. 3B shows an alternative embodiment of the connecter assembly (60, 65) that comprises an anchor (60). Where it is impractical or undesirable to use the ring (50) disclosed in the previous connector assembly (50, 55), an anchor (60) may be connected on or near the dispenser to facilitate the positioning of the present invention near the dispenser spigot (200). The anchor (60) may be connected to the dispenser in a variety of manners including mechanically or by adhesives. The leash (65) runs from the anchor (60) to the present invention, in a similar fashion as disclosed above. In yet another embodiment of the connector assembly (not pictured), the dispenser protector may be removably housed in a seat, the seat being mounted to or otherwise associated with the dispenser.

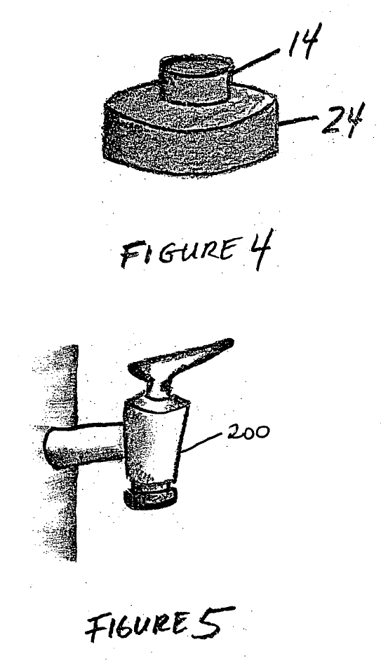

FIG. 4 illustrates an alternative embodiment of the present invention. In this embodiment, a plug (14) is inserted into the opening of a dispenser spigot (200) thereby providing the same benefits as described previously. In order to make this alternative embodiment of the present invention easier to use, an access structure (24) is generally associated with the plug (14) so that this alternative embodiment of the present invention may be easily removed from the dispenser spigot (200) after insertion. Once again, this alternative embodiment of the present invention may be mounted to dispenser (200) in a variety of ways known in the art including frictional contact, pressure fits and tapered shaping that allow for the plug (14) and the spigot (200) to remain associated.

FIG. 5 illustrates the present invention mounted to a typical dispenser spigot. The access structure (24) protrudes beyond the spigot (200) such that the present invention may be easily removed from the spigot (200).

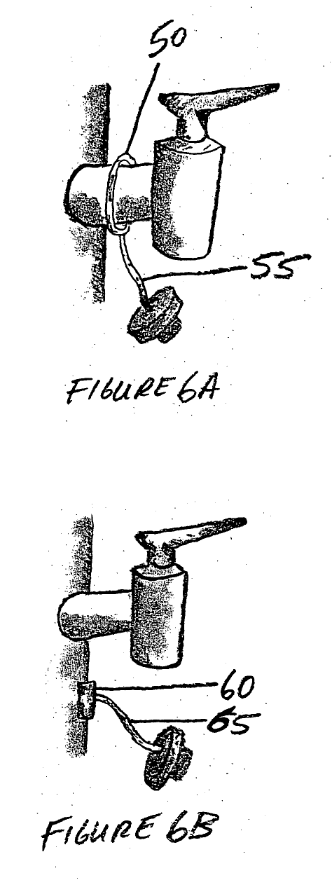

FIG. 6A illustrates the alternative embodiment of the present invention in conjunction with a connector assembly (50, 55). The connector assembly (50, 55) comprises a ring (50) that may be fit over a dispenser spigot (200), or otherwise mounted thereto. A leash (55) is connected to the ring (50) at one end. At the other end of the leash (55), the alternative embodiment of the present invention is connected. As such, the present invention (2) may be removed from the spigot (200) while, at the same time, allowing the present invention to be positioned near and accessible to the dispenser, as described and shown in FIG. 3A.

FIG. 6B shows an alternative embodiment of the connecter assembly (60, 65) that comprises an anchor (60). Where it is impractical or undesirable to use the ring (50) disclosed in the previous connector assembly (50, 55), an anchor (60) may be connected on or near the dispenser to facilitate the positioning of the present invention near the dispenser spigot (200). The anchor (60) may be connected to the dispenser in a variety of manners known in the art, including mechanically or by adhesives. The leash (65) runs from the anchor (60) to the present invention, in a similar fashion as disclosed in FIG. 3B.

What is claimed is:

1. A dispenser seal, comprising:
a fastener having a distal portion; and
a base positioned said distal portion of said fastener.

2. The dispenser seal in claim 1, wherein said fastener is constructed of flexible material.

3. The dispenser seal in claim 1, wherein said dispenser seal is constructed of flexible material.

4. The dispenser seal in claim 1, wherein said dispenser seal is constructed of material that may be repeatedly sanitized.

5. The dispenser seal in claim 1, wherein said dispenser seal is disposable.

6. The dispenser seal in claim 1, wherein said dispenser seal is of varying colors.

7. The dispenser seal in claim 1, wherein said dispenser seal is translucent.

8. The dispenser seal in claim 1, further comprising a connector assembly associated with said dispenser seal.

9. The dispenser seal in claim 8, wherein said connector assembly comprises a ring, said ring connected to a leash.

10. The dispenser seal in claim 8, wherein said connector assembly comprises an anchor, said anchor connected to a leash.

11. The dispenser seal in claim 8, wherein said connector assembly comprises a seat, said seat designed for the acceptance of said dispenser protector.

12. A dispenser seal, comprising:
a plug having a distal portion; and
an access structure disposed at said distal portion of said fastener.

13. The dispenser seal in claim 12, wherein said plug is constructed of flexible material.

14. The dispenser seal in claim 12, wherein said dispenser seal is constructed of flexible material.

15. The dispenser seal in claim 12, wherein said dispenser seal is constructed of material that may be repeatedly sanitized.

16. The dispenser seal in claim 12, wherein said dispenser seal is disposable.

17. The dispenser seal in claim 12, wherein said dispenser seal is of varying colors.

18. The dispenser seal in claim 12, wherein said dispenser seal is translucent.

19. The dispenser seal in claim 12, further comprising a connector assembly associated with said dispenser seal.

20. A method to protect a dispenser, comprising:
associating a plug to a dispenser spigot, said plug having an access structure.
